(19) United States
(12) Patent Application Publication
(10) Pub. No.: US 2004/0147304 A1
(43) Pub. Date: Jul. 29, 2004

(54) Gaming machine

(76) Inventor: Shingo Shimizu, Tokyo (JP)

Correspondence Address: VENABLE, BAETJER, HOWARD AND CIVILETTI, LLP, P.O. BOX 34385, WASHINGTON, DC, 20043-9998, US

(21) Appl. No.: 10/746,340

(22) Filed: Dec. 29, 2003

Related U.S. Application Data
(63) Continuation of application No. 09/432,420, filed on Nov. 2, 1999, now abandoned.

(30) Foreign Application Priority Data
Nov. 2, 1998 (JP) 10-312 228

(51) Int. Cl. A63F 13/00

(52) U.S. Cl. 463/16

(57) ABSTRACT

In a gaming machine which has a display arrangement for displaying symbols related to a game, the display arrangement includes a display screen that indicates symbols including special symbols for showing transfer to special game state when varying special symbols stop to produce a predetermined stop pattern, and predictive symbols for predicting appearance of the stop pattern. The stop screen indicates not only the symbols but also commentary information of game.

### CROSS REFERENCE TO RELATED APPLICATION

The application is a continuation application of Ser. No. 09/432,420, filed Nov. 2, 1999 and incorporated herein by reference.

### BACKGROUND OF THE INVENTION

1. Field of the Invention

The present invention relates to a gaming machine, such as pachinko game machine, which is provided with a symbol display arrangement for variably displaying a plurality of symbols necessary for a game and a controller such as a microcomputer for controlling the variable display of the symbol display arrangement.

2. Description of the Related Art

A pachinko game machine which is a kind of a ball-shooting gaming machine, for example, is provided with a symbol display arrangement that is arranged to start variation display of symbols when a determined condition is satisfied. If the variation display or symbols is stopped to form a predetermined combination of symbols, a player can obtain profits. In recent years, an electric display unit such as a liquid crystal display is popularly used as the symbol display arrangement due to the possibility of various demonstration effects.

By using such electric display unit, for example, it is possible to carry out the followings:

a real-time indication of times of open of a variable winning device converted into an open state or condition that is profitable for a player when the variable display is stopped in a specified combination of symbols (e.g. “big hit”);

a real-time indication of number of playing balls that entered the variable winning device; or

an indication of background in different color from usual when the stopped display indicates a specified pattern or symbols in order to demonstrate a “big hit” excitingly.

Also, it becomes possible to carry out various indications or demonstrations for increasing interests of a player. For example, when “big hit” can be obtained if one more special symbol will be arranged (that is, “reach state”), an indication of pattern with unusual motion makes a player recognize that a “big hit” will appear soon.

In particular, one of useful demonstrations to enhance interest of a player is a pattern or symbol variation in the “reach state,” that is called “reached action”. When the reach action begins, a player will pay attention to the indication display to expect an appearance of a a “big hit”. Examples of a “reach action,” demonstration may include (1) changes to the speed of pattern or symbol variation display that is different from the usual speed; (2) change to the time length of symbol variation. The “special reach action” sometimes indicates an appearance of a a “big hit” in 100%. Thus, such reach action is a predictive indication to make a player expect an appearance of a “big hit”.

Further, in the gaming machine that makes demonstration display such as “reach action,” it has been main to perform the demonstration display be means of any symbols (or characters) other than the varying symbols in addition to the symbol variation.

In recent years, there has been provided a gaming machine which can carry out various predictive displays (that is, “prognostic display”) even before the reach state appears. Such display can inform a player that a “big hit” is coming as well as the reach action. Also, such display can make a player predict whether or not it will transfer to a specified reach action (that is, “probability of development into reach state”).

According to such displays, it is possible to perform not only the prediction of appearance of a “big hit” but also a variety of demonstrations resulting in enhancement of interest in the whole game.

There has been raised a problem that it takes more time to understand contents of game because such demonstration displays tend to increase contents more and more. Therefore, in a game hall, sometimes brief explanation illustrates characters or contents of game by means of printed matter to assist a player to understand the contents of game or select a suitable gaming machine.

However, such explanation indicates only a part of game contents, and it is not given on every gaming machines but in only one place of the hall. Therefore, it is hard to say that such explanation assists a player to understand the contents of game enough.

In Japanese Patent Laid-Open Publication No. 9-4334, there is disclosed a gaming machine having a display arrangement for variably displaying symbols, that can display a situation of “reach state” established up to the present time since the last a “big hit” in a part of display screen of the display arrangement. However, this informs only results of “reach state” establishment and it does not provide a commentary information such as an explanation of game contents.

### SUMMARY OF INVENTION

An object the present invitation is to provide a gaming machine having a display arrangement for displaying symbols related to a game, in which the display arrangement can be used for providing commentary information of the game.

In accordance with the present invention, a gaming machine has a display arrangement for displaying symbols related to a game, in which the display arrangement can be used for providing commentary information of the game.

In accordance with the present invention, a gaming machine has a display arrangement for displaying symbols related to a game, the symbols including varying special symbols for indicating transfer to a special game state when the varying special symbols stop to produce a predetermined stop pattern, and predictive symbols for predicting appearance of the stop pattern. The display arrangement is arranged to display not only the symbols but also commentary information of the game.

Therefore, it is possible to provide more information that can help understanding of contents of game and to communicate a fundamental concept of game in the display arrangement to a player with ease. If a player is a beginner, he or she can understand the contents of game sufficiently and attend the game.

In an embodiment of the invention, the commentary information is displayed in a predetermined time interval when the game is not carried out in the display arrangement. A player can learn contents of game with use of duration when the game is not played in the display arrangement.

In another embodiment of the invention, the display arrangement starts display of the commentary information when the game is not carried continuously in a predetermined time period and the display arrangement stops the display of the commentary information when the game is started. Thus, the commentary information can be displayed without waste of time.

In other embodiment of the invention, the commentary information is displayed when a predetermined display instruction is given. By using such instruction, a player can watch the commentary information at any time when he or she desires.

In other embodiment of the invention, the commentary information comprises a plurality of display contents that can be changed by the display instruction. A player can select the commentary information that he or she wants to know by change of the display contents. Further, if the display instruction is produced by a plurality of operable switches corresponding to each of the display contents, a player can easily produce the display instruction and quickly obtain the commentary information that he or she wants to know.

In other embodiment of the invention, the commentary information is optional one of performance of the game, explanation about a concept of the game, explanation about a process of the game, explanation about prognostic display, explanation about reach display, explanation about likelihood of a “big hit” that is indicated by the prognostic display and the reach display, explanation about symbols to be displayed, and other information of the game. For such commentary information, a player can understand detail of the game with ease.

### BRIEF DESCRIPTION OF THE DRAWINGS

The foregoing and other objects, features, and advantages of the invention will become more apparent from the following detailed description taken in conjunction with the accompanying drawings, in which:

FIG. 1 shows a front gaming portion of a pachinko game machine according to an emobidment of the invention:

FIG. 2 is a front view of a liquid crystal display;

FIG. 3 is a front view of the pachinko game machine having commentary display switches.

FIG. 4 is a perspective view of an upper tray provided with the commentary display switches.

FIG. 5 is a table showing contents of three commentary information groups;

FIG. 6 shows a display of “explanation about concept of game”;

FIG. 7 shows a display of “introduction of a character”;

FIG. 8 shows a display of “explanation about a flow of game”;

FIG. 9 shows a display of “performance information of a gaming machine”;

FIG. 10 shows a display of “explanation about word prognostic”;

FIG. 11 shows a display of “word prognostic list”;

FIG. 12 shows a display of “explanation about action prognostic”;

FIG. 13 shows a display of “action prognostic symbol”;

FIG. 14 shows a display of “explanation about reach demonstration symbol”;

FIG. 15 is a block diagram of constitution of electric circuit portions of the pachinko game machine:

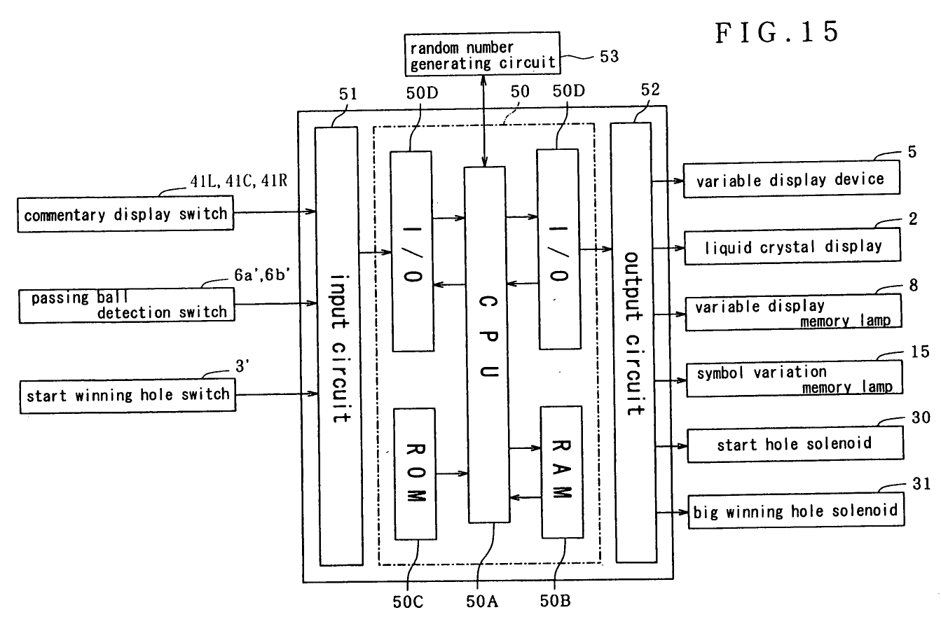

### DETAILED EXPLANATION OF THE PREFERRED EMBODIMENT

A pachinko game machine that is an embodiment of the present invention will be explained in detail below.

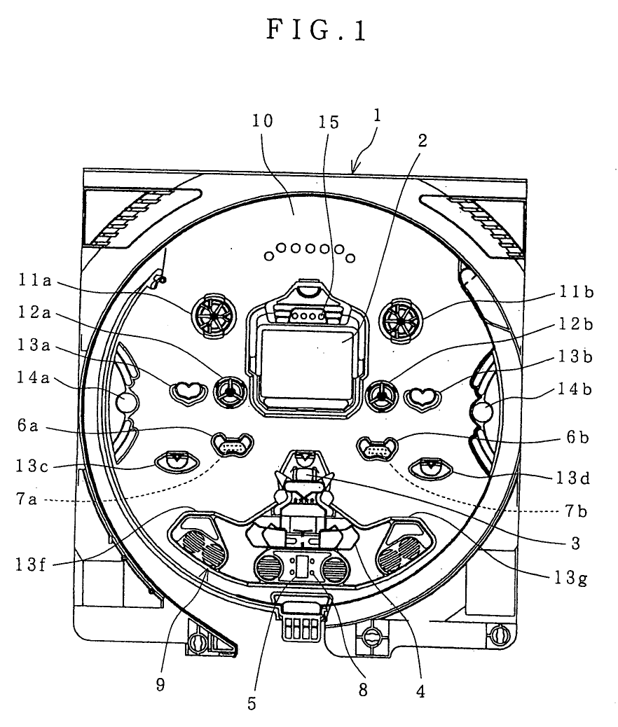

FIG. 1 shows a front view of a game board face 10 of pachinko game machine 1. A liquid crystal display 2 as a symbol display arrangement is provided in the center of the game board face 10. The liquid crystal display 2 is arranged to variably display a plurality of symbols expressed by pictures to stimulate three rows of rotatable reels of a slot machine. Each of these symbols to be variably displayed is called “special symbol”. If variation of the special symbols stops at a predetermined stop pattern (for example, “7-7-7” called a “big hit”), then state of game transfers to a special game state that is advantageous to a player. The special game state will be explained hereinafter.

The liquid crystal display 2 displays “prognostic demonstration” symbols and “reach demonstration” symbols during variation display of the special symbol. The demonstration symbols are for predicting that the special symbol will stop at a predetermined stop pattern to indicate transfer to the special game state, or that the display will develop into a special “reach action”. The reach demonstration symbol indicates “reach state” that a predetermined stop pattern may be produced if one more special symbol is stopped. These prognostic demonstration and reach demonstration symbols are expressed with various pictures.

In this embodiment, as shown in FIG. 1, special symbols 20L, 20C, 20R are variably displayed in a lower portion of display screen 2a of the liquid crystal display 2. The prognostic demonstration and reach demonstration symbols are displayed in the other portion of the display screen. The special symbols 20L, 20C, 20R are displayed in response to electrical signals, thereby simulating symbols on three rows of rotatable reels of a slot machine. Prognostic or reach demonstration is illustrated by symbols, characters, animation and the like. Here, three girl characters 21L, 21C, 21R are displayed demonstration symbols corresponding to special symbols 20L, 20C, 20R respectively, each of which is variably displayed.

The prognostic demonstration symbol is used for predicting that variations display of the special symbols 20L, 20C, 20R will be a reach state, or that display will be a predetermined pattern indicating “big hit,” for example “7-7-7” when variation of display is stopped through a reach state. Such prognostic demonstration symbol is constituted so that the state of display can change to various patterns. The prognostic demonstration symbol (each character 21L, 21C, 21R of three girls) can be varied with display contents relevant to each other. The likelihood of a “big hit” and the probability of development into reach are different in accordance with contents of the relevance.

More specifically, corresponding to the variation display of special symbols 20L, 20C, 20R, facial expression and posture of the characters 21L, 21C, 21R as prognostic demonstration symbol are varied. The other symbols can be displayed corresponding to each of characters 21L, 21C, 21R, or the characters can be displayed to talk to each other with words.

As for the variation of display states of such prognostic demonstration symbol, contents of the variation have relevance to relations among characters 21L, 21C, 21R. The likelihood of a “big hit” and the probability of the development into “reach” are different in accordance with contents of the relations. Accordingly, if a player recognizes what kind of relations the display of prognostic demonstration symbol is varied with, a player can predict in a certain degree whether the development into “reach” or the appearance of a “big hit” will be expected.

Also, when the “reach” state is established, a reach demonstration symbol is displayed rather than a prognostic demonstration symbol as the demonstration display for information of the “reach” state. The reach demonstration symbol is displayed in different modes in accordance with the likelihood of a “big hit”.

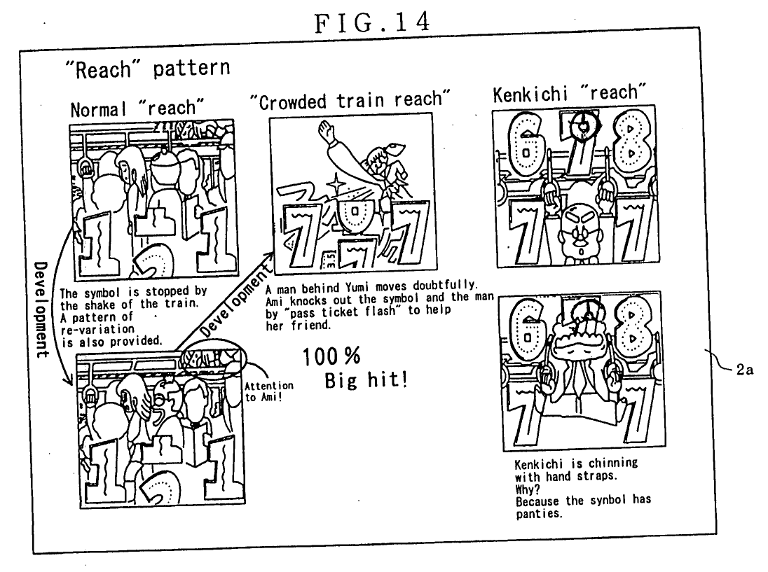

The above-mentioned displays can be realized by storing a plurality of different prognostic and reach demonstration symbols corresponding to the likelihood of a “big hit” and the probability of the development into “reach” in a memory (ROM 50C shown in FIG. 14).

As shown in FIG. 1 again, a start winning hole (that is, “starter hole”) 3 is arranged below the liquid crystal display 2 for starting the symbol variation when a playing ball enters the start winning hole 3. The start winning hole 3 may be a variable winning device that is convertible between a first condition disadvantageous to a player and a second condition advantageous to a player. When a playing ball enters the start winning hole 3, a predetermined number of prize balls (for example, five balls) are paid.

A playing ball can enter the start winning hole 3 even when the hole is in the first condition disadvantageous to a player, because the start winning hole 3 has enough space for a playing ball to enter even in the first condition.

Four symbol variation memory lamps 15 are disposed above the liquid crystal display 2. The symbol variation memory lamps 15 are arranged to indicate the number of winning time of playing ball entered the star winning hole 3 up to four times during variation displayed in special symbol 20L, 20C, 20R of the display screen 2a. The symbol variation member lamps 15 give a real time information of number of times of variation successively displayed by the liquid crystal display 2 to a player. The winning time more than five times are made ineffective for the starting condition of variation display.

Below the start winning hole 3 is provided a big winning hole (that is “attacker”) 4 that can have a closed disadvantageous to a player and an opened condition advantageous to a player. The big winning hole 4 may be a door open/close type variable winning device that is converted to the opened condition when the variation display of the symbol in the display screen 2a of the liquid crystal display 2 is stopped in a specified symbol combination corresponding to the a “big hit”. When a playing ball enters the big winning hole 4, a predetermined number of prize balls (for example, fifteen balls) are paid. The special game state is a condition that the big winning hole 4 is opened and the variation time of symbol in liquid crystal display 2 is shortened so as to increase chance of enter to the start winning hole 3.

A variable display device 5 is disposed in the lower portion of the game board face 10. The variable display device 5 is arranged to start the variation display when a playing ball passes through a variable display actuation gate 6a or 6b disposed in left and right sides, respectively, of the liquid crystal display 2. When the variable display device is stopped to display a predetermined special symbol, the start winning hole 3 is converted into the second condition that is advantageous to a player.

Four variable display memory lamps 8 are disposed around the variable display device 5. The variable display memory lamps 8 are arranged to indicate number of time of playing ball passing through a variable display actuation gate 6a or 6b up to four times. The variable display member lamps 8 give to a player the information of number of times of variation successively displayed by the variable display device 5. The passing time more than five times are not counted and made ineffective.

The game board face 10 is further provided with windmills 11a, 11b that each have a lamp as a light emitting portion, and normal windmills 12a, 12b. The game board face 10 is further provided with usual winning holds 13a, 13b, 13d, 13f, 13g and game board side lamps 14a, 14b. Every time when a playing ball enters the usual winning hole, fifteen prize balls are paid.

The variable display device 5, the start winning hole 3, and the big winning hole 4 are integrated together with the usual winning holes 13f and 13g to form a unit for a variable winning ball device 9 that is arranged on the game board face 10.

Further, in the liquid crystal display 2, commentary information about a game is displayed as well as symbol display such as special symbols 20L, 20C, 20R and the prognostic demonstration symbol. For example, the commentary information is explanation about the prognostic and reach demonstration symbols, or explanation about a flow of the whole game and the like.

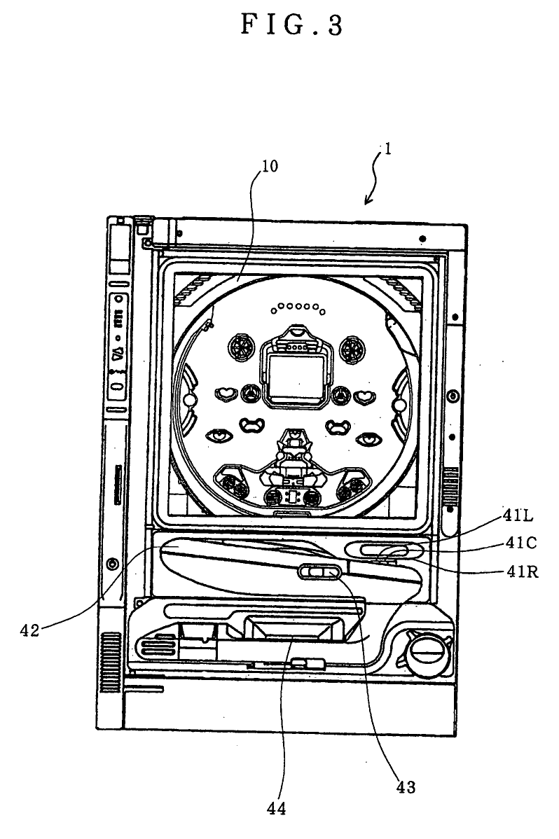

The commentary information about a game in this liquid crystal display 2 can be displayed by operating a predetermined display instruction means. As the display instruction means, commentary display switches 41L, 41C, 41R that can cause display of commentary information and change of display contents by push operation are provided. The commentary display switches 41L, 41C, 41R are each arranged in the right—side end of an upper tray 42 provided in a middle position of the gaming machine 1 as shown in FIG. 3.

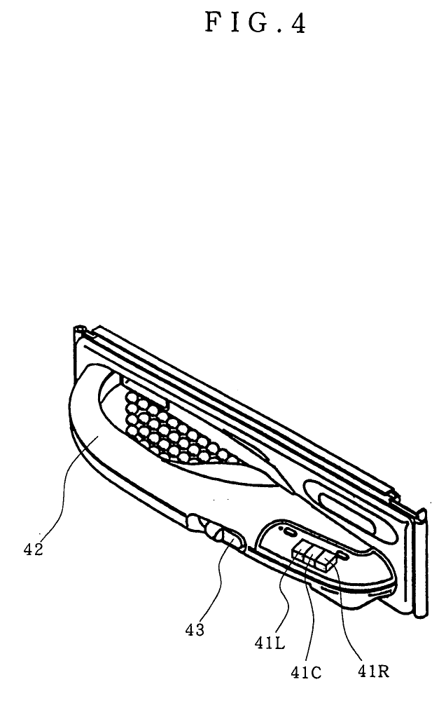

FIG. 4 shows the upper tray 42 viewed from upper part. The upper tray 42 is arranged as a saucer for receiving playing balls that have been paid. The playing balls collected in the upper tray are dropped to a lower tray 44 by a player's operation of a ball-out lever 43. Because this operation is done frequently, the lever 43 is disposed in a position to be operated with ease. Also, the commentary display switches 41L, 41C, 41R are arranged in a position to be operated easily by a player, thus the player can easily for displaying the commentary information.

The commentary information includes a plurality of display contents, and contents of commentary information displayed in response to each of the commentary display switches 41L, 41C, 41R are different each other.

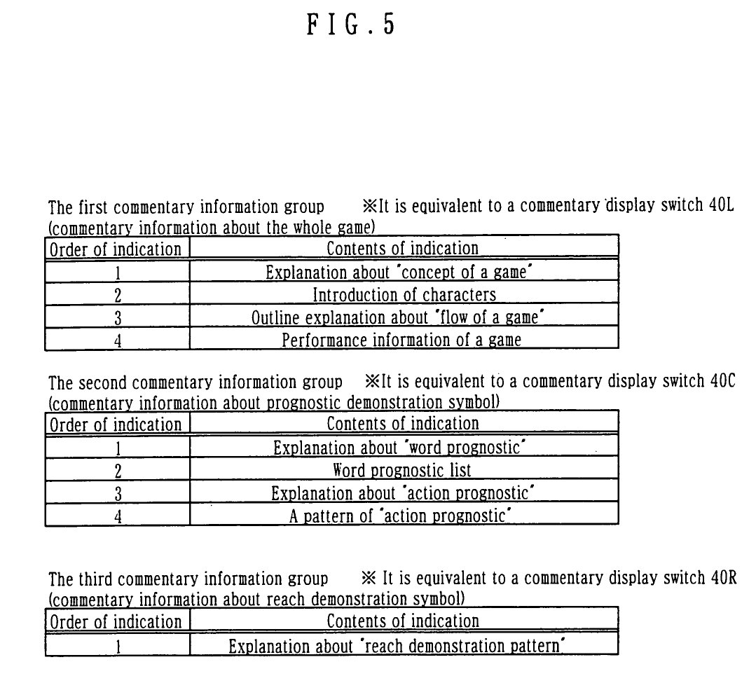

The commentary information is classified to three groups that are of “commentary about the whole game,” commentary about prognostic demonstration symbol” and “commentary about reach demonstration symbol”. Each of three commentary information groups consists of a plurality of commentary information as shown in FIG. 5, and is stored in ROM 50C shown in FIG. 14.

Each of the commentary display switches 41L, 41C, 41R corresponds to each of three commentary information groups, and can change the display contents in order of numbers shown in FIG. 5 by the pushing operation of each switch. Display contents of the first commentary information group shown in FIG. 5 are displayed in the display screen 2a in order by push operation of commentary display switch 41L. Display contents of the second commentary information group shown in FIG. 5 are displayed in the display screen 2a in order by push operation or commentary display switch 41C. Display contents of the third commentary information group shown in FIG. 5 are displayed in the display screen 2a by push operation of commentary display switch 41R.

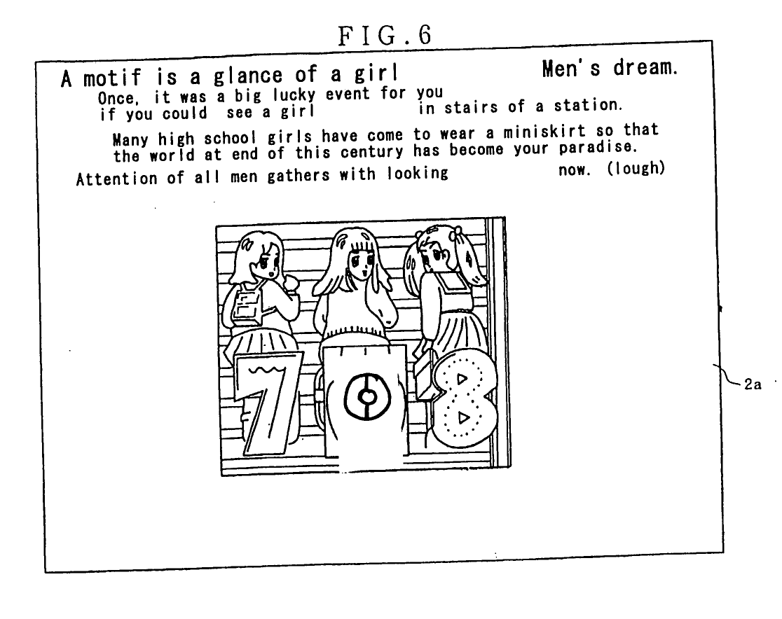

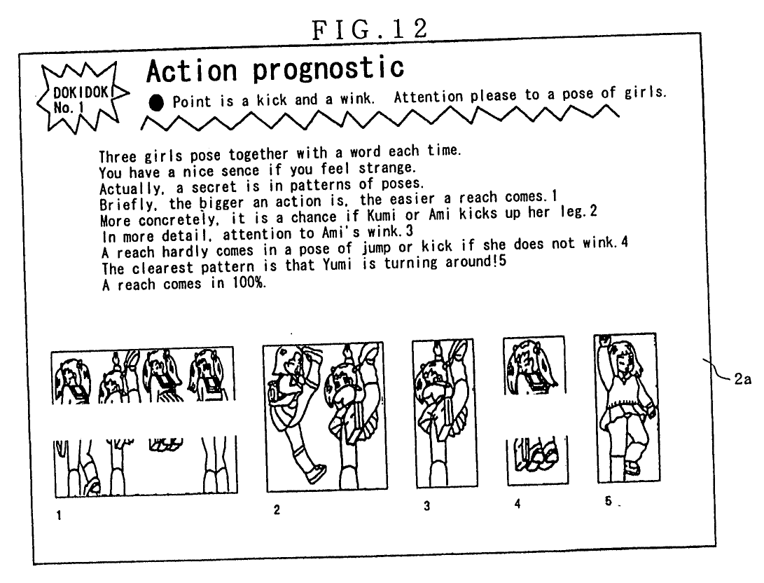

FIGS. 6 to 12 are shown examples of display contents of FIG. 5.

First, referring to FIGS. 6 to 9, the first commentary information group of FIG. 5 that is “commentary information about the whole game” displayed by operation of commentary display switch 41L will be explained.

FIG. 6 shows display explanation about “concept of game”. According to this display, interests to a game displayed on the display screen 2a can be increased, and an advertising effect to hold interests to the gaming machine can be expected for a beginner.

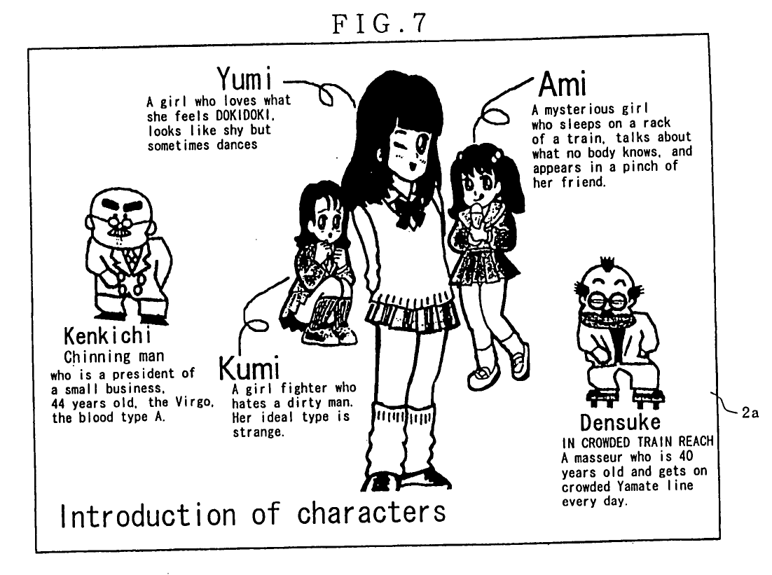

FIG. 7 shows display “introduction of character” appearing in the game displayed on the display screen 2a. According to this display, a player can have a good understanding of characters appearing in a game to be played from now on and also have a friendly feeling to each character to attend a game. The player's interest to a game increases still more.

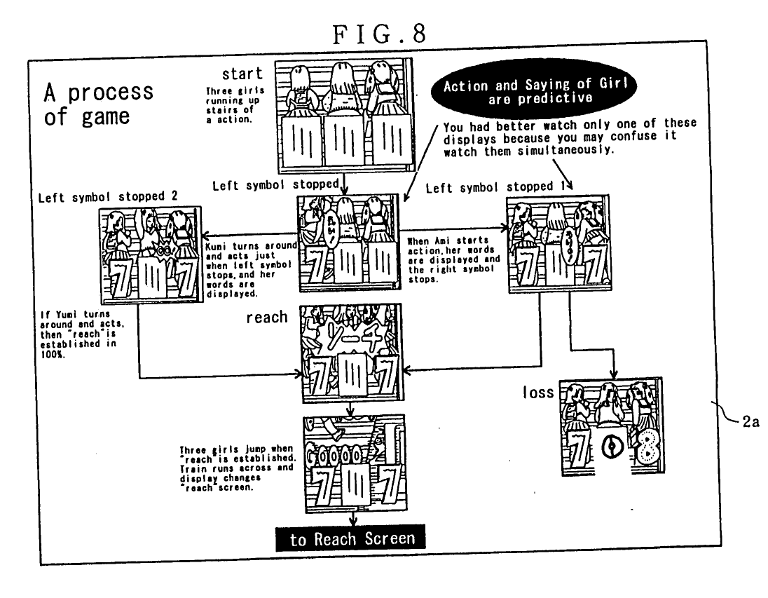

FIG. 8 shows display outline explanation about “flow of game” to be played on the display screen 2a. According to this display, a player can easily grasp an outline about the flow of the whole game to be displayed on the display screen 2a, such as timing when prognostic display appears.

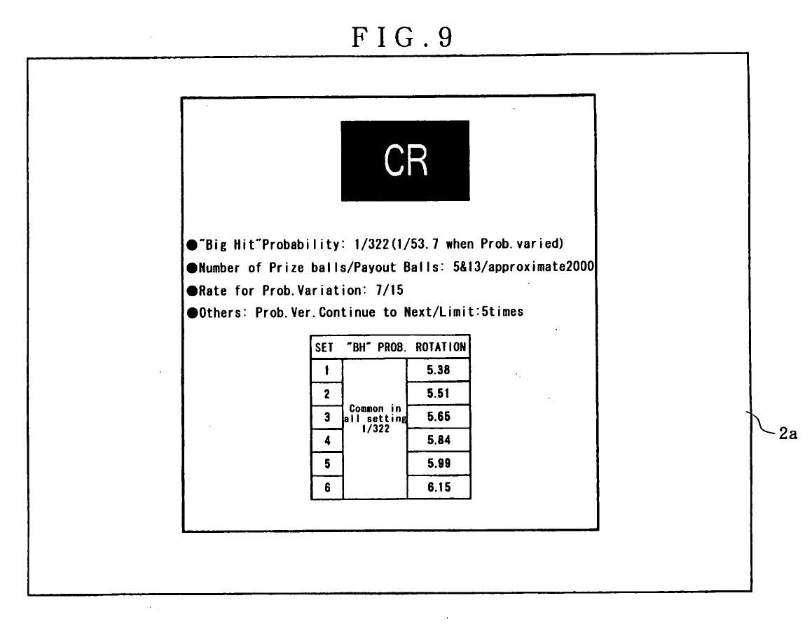

FIG. 9 shows display of “performance information of game”. According to this display, a player can easily understand a difference of performance with other gaming machines. This display is useful in selection of gaming machine.

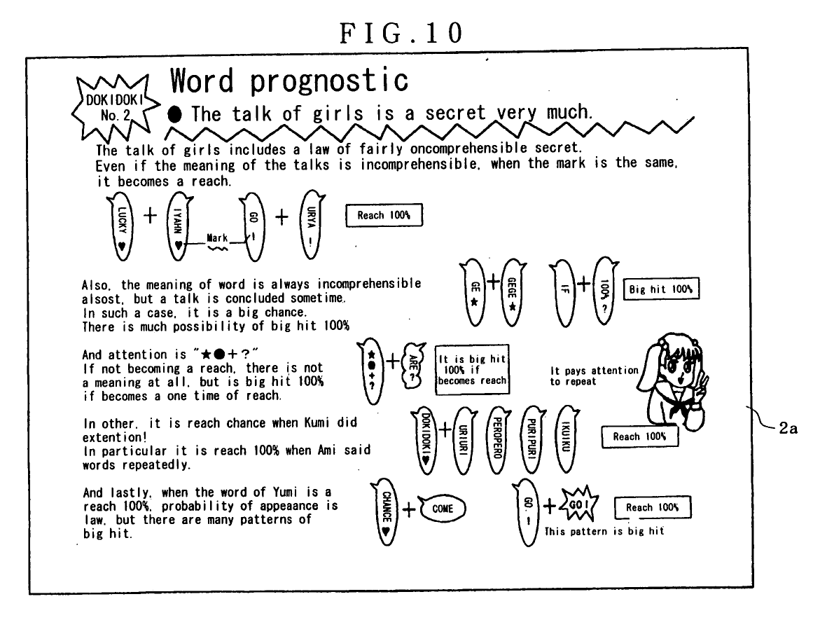

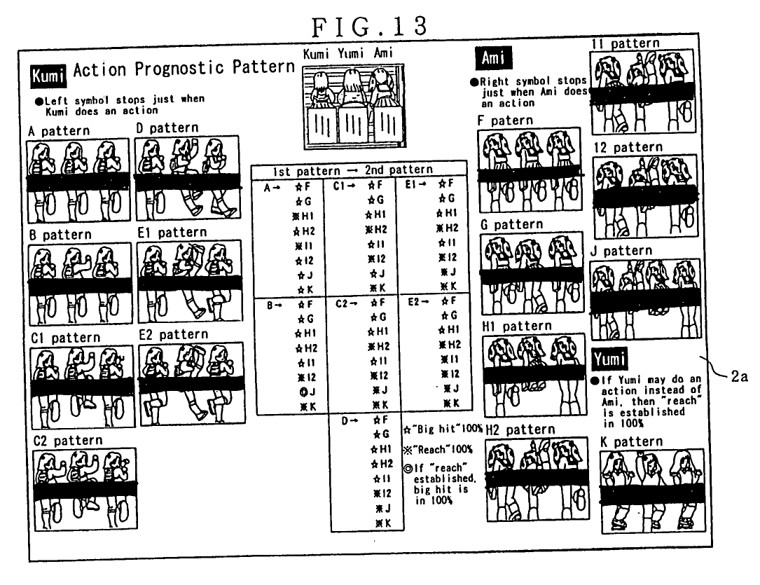

Next, referring to FIGS. 10 to 13, the second commentary information group of FIG. 5 that is “commentary information about prognostic symbol” displayed by operation of commentary display switch 41C will be explained.

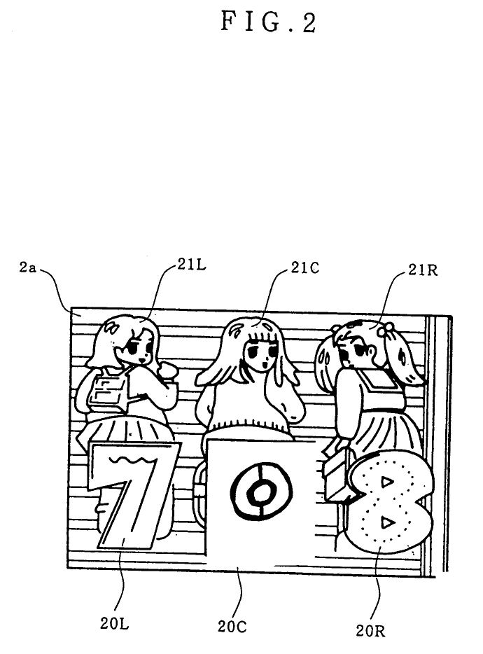

In the example, the prognostic demonstration symbol consists of “word prognostic” and “action prognostic”. The “word prognostic” is a prognostic display in which each of three girl characters 21L, 21C, 21R shown as the prognostic demonstration symbol in FIG. 2 talks each other. For example, sayings or words are displayed by symbols or characters. Also, they may be expressed by sound.

The “action prognostic” is a prognostic display in which three girl characters take any action. For example, “action” is a variation of facial expression of characters, variation of posture and the like. The “action prognostic” can be displayed usually in combination with the “word prognostic”.

FIG. 10 shows display explanation about the “word prognostic”. According to this display, a player can grasp an outline about prognostic contents meant by sayings that each of three girl characters 21L, 21C, 21R as the prognostic demonstration symbol tells.

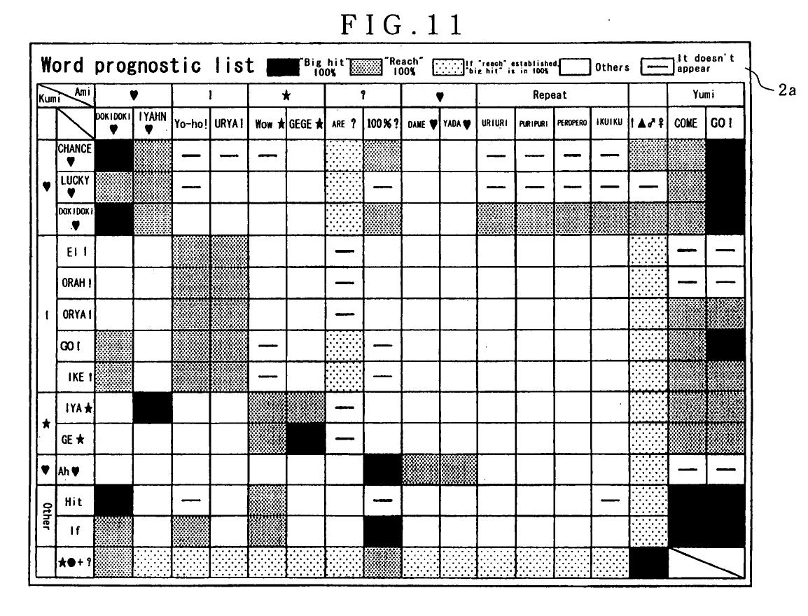

FIG. 11 shows display explanation about the likelihood of a “big hit” and the probability of the development to “reach” that the “word prognostic” predicts. It shows by a matrix the likelihood of a “big hit” and the probability of development to “reach” which are different in combination of “word prognostic” that three girl characters tell each other.

What is claimed is:

1. A gaming machine comprising:
a display arrangement for displaying symbols related to a game when the game is in progress, said symbols comprising
varying special symbols for indicating transfer to a special game state when the varying special symbols stop to produce a predetermined stop pattern, and
demonstration symbols for predicting the appearance of the stop pattern, said demonstration symbols illustrating predictive information relating to a reach state condition, said reach state condition indicating a higher probability of said special symbols stopping at said predetermined stop pattern and
said demonstration symbols further illustrating predictive information for a second big hit condition, said second big hit condition comprising a condition when the game will likely award a player a big hit, wherein said demonstration symbols are capable of being understood by a player as signifying the prediction of either a favorable reach or big hit condition or an unfavorable reach or big hit condition, and
said display arrangement is arranged to further provide a descriptive commentary information during the game or when the game is not in progress, said descriptive commentary information being provided for the understanding of a relation between the demonstration symbols and the stop pattern, and the general understanding of the game.

2. The gaming machine of claim 1, wherein said commentary information is provided in a predetermined time interval when the game is not in progress.

3. The gaming machine of claim 1, wherein said display arrangement is arranged to continuously display said commentary information when the game is not carried out in a predetermined time period and to stop the commentary information display when the game is started.

4. The gaming machine of claim 1, wherein said commentary information is provided when a predetermined display instruction is given.

5. The gaming machine of claim 4, wherein the commentary information display comprises a plurality of groups of display contents that can be selected by said predetermined display instruction.

6. The gaming machine of claim 5, wherein said display instruction is produced by the activation of a plurality of switches each of which is associated to each group of display contents.

7. The gaming machine of claim 1, wherein said commentary information comprises a display of an explanation about any one of
the performance of the game,
a concept of the game,
a process of the game, and
a prognostic display, said prognostic display comprising both reach displays, and likelihood of big hit displays.

8. A gaming machine comprising
a variable display arrangement for displaying symbols related to a game when the game is in progress, said symbols including varying special symbols for indicating transfer to special game state when the varying special symbols stop to produce a predetermined stop pattern, and demonstration symbols for predicting the appearance of said stop pattern,
wherein said special symbols comprise alpha-numeric characters, and
wherein said demonstration symbols comprise characters performing actions, said actions relating to the probability of the appearance of said stop pattern, and
said display arrangement further provides descriptive commentary information during the game or when the game is not in progress, said information relating to an explanation of the relation between the demonstration symbols and said stop pattern, and an explanation of how to play the game.

9. The gaming machine of claim 8, wherein said commentary information display is provided in a predetermined time interval when the game is not in progress.

10. The gaming machine of claim 8, wherein said display arrangement is arranged to begin the display of said commentary information when the game is not in operation and to stop the commentary information display when the game is in operation.

11. The gaming machine of claim 8, wherein said commentary information is provided in response to a predetermined instruction provided as input by a player.

12. The gaming machine of claim 8, wherein said commentary information comprises a plurality of groups of display contents that can be selected by a player by selecting an input corresponding to predetermined display instructions.

13. The gaming machine of claim 8, wherein said display instruction input is produced by a plurality of switches each of which is associated to each said group of display contents.

14. The gaming machine of claim 8, wherein said commentary information is a display of textual information comprising an explanation of
the performance of the game,
the concepts of the game,
the process of the game, and said variable display further comprises a
a prognostic display feature, and said prognostic display feature comprises information relating to a reach display or likelihood of a big hit display.

15. The gaming machine of claim 11, wherein said commentary information is provided in a predetermined time interval when the game is not in progress.

16. The gaming machine of claim 11, wherein said commentary information is continuously displayed during a predetermined time period when the game is not in operation and is stopped when the game is started.
